(19) United States
(12) Patent Application Publication
(10) Pub. No.: US 2020/0014599 A1
(43) Pub. Date: Jan. 9, 2020

(54) APPARATUS AND METHOD FOR REQUESTING NARROWER BANDWIDTH CHANNEL TO ADDRESS COMMUNICATION LINK ISSUE

(71) Applicant: QUALCOMM Incorporated, San Diego, CA (US)

(72) Inventors: Alfred ASTERJADHI, San Diego, CA (US); Abhishek Pramod PATIL, San Diego, CA (US); George CHERIAN, San Diego, CA (US)

(21) Appl. No.: 16/460,821

(22) Filed: Jul. 2, 2019

Related U.S. Application Data
(60) Provisional application No. 62/694,907, filed on Jul. 6, 2018.

(51) Int. Cl. H04L 12/24; H04W 72/08; H04W 72/12; H04W 52/02

(52) U.S. Cl. CPC H04L 41/0896; H04W 52/0235; H04W 72/1284; H04W 72/087

(57) ABSTRACT

An access terminal that may be experiencing or that anticipates experiencing link closure issues sends a frame to an access point. The frame includes a request to the access point to assign different transmit channel parameters for the access terminal. In response to the frame, the access point sends a frame to the access terminal with the assignment of the different transmit channel parameters. The access terminal then uses the different transmit channel parameters to send frames to the access point. The different parameters may specify a narrower bandwidth channel. The transmit power spectral density associated with the narrower transmit channel is higher than the previously wider transmit channel assigned to the access terminal. As a result, the transmit range of the access terminal is increased to resolve the actual link closure issue or prevent a potential link closure issue. The parameter reassignment also applies to when the link improves.

### CROSS-REFERENCE TO RELATED APPLICATION

This application claims the benefit of the filing date of U.S. Provisional Application, Ser. No. 62/694,907, filed on Jul. 6, 2018, which is incorporated herein by reference.

### FIELD

Certain aspects of the present disclosure generally relate to wireless communications and, more particularly, to an apparatus and method for requesting a narrower bandwidth channel to address communication link issue.

### BACKGROUND

In certain situations, an access terminal (generally, a wireless node) may have been assigned a channel having a relatively wide bandwidth for communicating with an access point (also generally, a wireless node). If the access terminal is sufficiently close in distance to the access point, the quality of the communication link between the access terminal and the access point is sufficient to allow frames to be successfully transmitted and received between the wireless nodes.

However, if the access terminal moves farther away from the access point or the access terminal changes its mode of operation to a lower power consumption mode where its maximum transmit power is intentionally reduced, the quality of the communication link between the access terminal and the access point may not be sufficient to allow frames to be successfully transmitted and received between the wireless nodes using the relatively wide bandwidth. The communication link issue may be worse in the uplink direction (from the access terminal to the access point) as the access terminal typically has a lower transmit power than the access point.

### SUMMARY

A first aspect relates to an apparatus for wireless communications. The apparatus comprises a processing system configured to generate a first frame including a request for an assignment for the apparatus from a first set of channel parameters to a second set of channel parameters, and generate a second frame; and an interface configured to output the first frame for transmission to a wireless node in accordance with the first set of channel parameters, obtain a third frame from the wireless node, wherein the third frame includes the assignment of the second set of channel parameters, and output the second frame for transmission to the wireless node in accordance with the second set of channel parameters.

A second aspect relates to a method for wireless communications. The method comprises generating a first frame including a request for an assignment from a first set of channel parameters to a second set of channel parameters; outputting the first frame for transmission to a wireless node in accordance with the first set of channel parameters; obtaining a second frame from the wireless node, wherein the second frame includes the assignment of the second set of channel parameters; generating a third frame; and outputting the third frame for transmission to the wireless node via the second set of channel parameters.

A third aspect relates to an apparatus for wireless communications. The apparatus comprises means for generating a first frame including a request for an assignment from a first set of channel parameters to a second set of channel parameters; means for outputting the first frame for transmission to a wireless node via the first set of channel parameters; means for obtaining a second frame from the wireless node, wherein the second frame includes the assignment of the second set of channel parameters; means for generating a third frame; and means for outputting the third frame for transmission to the wireless node in accordance with the second set of channel parameters.

A fourth aspect relates to a computer readable medium. The computer readable medium comprises instructions stored thereon for generating a first frame including a request for an assignment from a first set of channel parameters to a second set of channel parameters; outputting the first frame for transmission to a wireless node in accordance with the first set of channel parameters; obtaining a second frame from the wireless node, wherein the second frame includes the assignment of the second set of channel parameters; generating a third frame; and outputting the third frame for transmission to the wireless node in accordance with the second set of channel parameters.

A fifth aspect relates to a wireless node. The wireless node comprises a processing system configured to generate a first frame including a request for an assignment for the wireless node from a first set of channel parameters to a second set of channel parameters, and generate a second frame; a receiver configured to receive a third frame from another wireless node, wherein the third frame includes the assignment of the second set of channel parameters; and a transmitter configured to transmit the first and second frames to the another wireless node in accordance with the first and second sets of channel parameters, respectively.

A sixth aspect relates to an apparatus for wireless communications. The apparatus comprises an interface configured to obtain a first frame from a wireless node in accordance with a first set of channel parameters, wherein the first frame includes a request for an assignment for the wireless node from a first set of channel parameters to a second set of channel parameters, output a second frame for transmission to the wireless node, and obtain a third frame from the wireless node in accordance with the second set of channel parameters; and a processing system configured to generate the second frame based on the request, wherein the second frame includes an assignment of the second set of channel parameters to the wireless node.

A seventh aspect relates to a method for wireless communications. The method comprises receiving a first frame from a wireless node in accordance with a first set of channel parameters, wherein the first frame includes a request for an assignment for the wireless node from the first set of channel parameters to a second set of channel parameters; generating a second frame based on the request, wherein the second frame includes an assignment of the second set of channel parameters to the wireless node; outputting the second frame for transmission to the wireless node; and receiving a third frame in accordance with the second set of channel parameters.

An eighth aspect relates to an apparatus for wireless communications. The apparatus comprises means for receiving a first frame from a wireless node in accordance with a first set of channel parameters, wherein the first frame includes a request for an assignment for the wireless node from the first set of channel parameters to a second set of channel parameters; means for generating a second frame based on the request, wherein the second frame includes an assignment of the second set of channel parameters to the wireless node; means for outputting the second frame for transmission to the wireless node; and means for receiving a third frame in accordance with the second set of channel parameters.

A ninth aspect relates to a computer readable medium. The computer readable medium comprises receiving a first frame from a wireless node in accordance with a first set of channel parameters, wherein the first frame includes a request for an assignment for the wireless node from the first set of channel parameters to a second set of channel parameters; generating a second frame based on the request, wherein the second frame includes an assignment of the second set of channel parameters to the wireless node; outputting the second frame for transmission to the wireless node; and receiving the third frame in accordance with the second set of channel parameters.

A tenth aspect relates to a wireless node. The wireless node comprises a receiver configured to receive the first and second frames in accordance with first and second sets of channel parameters, respectively, wherein the first frame includes a request for an assignment for the second set of channel parameters to the another wireless node; a processing system configured to generate a third frame based on the request, wherein the third frame includes the assignment of the second set of channel parameters to the another wireless node; and a transmitter configured to transmit the third frame to the wireless node.

### BRIEF DESCRIPTION OF THE DRAWINGS

FIG. 1 illustrates an example wireless communication system in accordance with certain aspects of the present disclosure.

FIG. 2 illustrates a block diagram of an example access point and access terminal in accordance with certain aspects of the present disclosure.

FIG. 3 illustrates an example method of requesting and being assigned a narrower bandwidth channel in accordance with certain aspects of the present disclosure.

FIG. 4 illustrates a diagram of resource units (RUs) for communication between at least two wireless nodes in accordance with certain aspects of the present disclosure.

FIG. 5A illustrates a timing diagram of an example trigger-based uplink communication session including RU allocation for each participating station for use in transmitting uplink frames to an access point in accordance with certain aspects of the present disclosure.

FIG. 5B illustrates a diagram of an example trigger frame in accordance with certain aspects of the present disclosure.

FIG. 5C illustrates a diagram of an example user information field of a trigger frame in accordance with certain aspects of the present disclosure.

FIG. 6A illustrates a timing diagram of an example downlink communication session with a responsive uplink communication session in accordance with certain aspects of the present disclosure.

FIG. 6B illustrates a diagram of an example data or control frame in accordance with certain aspects of the present disclosure.

FIG. 6C illustrates a diagram of an example triggered response scheduling (TRS) field of the data or control frame in accordance with certain aspects of the present disclosure.

FIG. 7A illustrates a diagram of an example operation mode (OM) field of a data or control frame in accordance with certain aspects of the present disclosure.

FIG. 7B illustrates a table of values and meaning of an example uplink multiple unit (UL MU) Disable and Data Disable subfields of the OM field in accordance with certain aspects of the disclosure.

FIG. 8 illustrates a diagram of an example uplink power headroom (UPH) subfield of a high throughput (HT) control field of the data or control frame in accordance with certain aspects of the disclosure.

FIG. 9 is a flowchart of a method for wireless communications in accordance with certain aspects of the present disclosure.

FIG. 10 is a flowchart of another method for wireless communications in accordance with certain aspects of the present disclosure.

FIG. 11 illustrates an example device in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “example” is used herein to mean “serving as an example, instance, or illustration.” Any aspect described herein as “example” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

A station communicating with an access point with a set of channel parameters may encounter or anticipate encountering difficulties closing a link with the access point (for example, the station may not receive acknowledgments to frames transmitted to the access point). To address the actual or anticipated link closure issue, the station sends a frame including a request to the access point for a different set of channel parameters that may or would resolve the link closure issue. In response to the request, the access point sends a frame assigning the different set of channel parameters to the station. In response, the station transmits frames to the access point in accordance with the different set of channel parameters. Due to the different set of channel parameters, the station is now able to close the link with the access point.

The different set of channel parameters may specify a narrower bandwidth. Due to the narrow bandwidth, the station is able to transmit with a greater range to improve the access point's ability to receive frames from the station and to send acknowledgements to the station, thereby closing the link. The different set of channel parameters also may specify a different modulation coding scheme (MCS), which can improve the likelihood of the access point receiving frames from the station and sending acknowledgements to the station, thereby closing the link.

As one advantage of various implementations described herein, a station is able to address actual or anticipated difficulties with closing a link with an access point (or other station in a peer-to-peer communication network) by sending a request for a different set of channel parameters that would improve the ability of the access point or other station to successfully receive frames from the station.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple access terminals. A TDMA system may allow multiple access terminals to share the same frequency channel by dividing the transmission signal into different time slots, each time slot being assigned to different access terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

With reference to the following description, it shall be understood that not only communications between access points and user devices are allowed, but also direct (e.g., peer-to-peer) communications between respective user devices are allowed. Furthermore, a device (e.g., an access point or user device) may change its behavior between a user device and an access point according to various conditions. Also, one physical device may play multiple roles: user device and access point, multiple user devices, multiple access points, for example, on different channels, different time slots, or both.

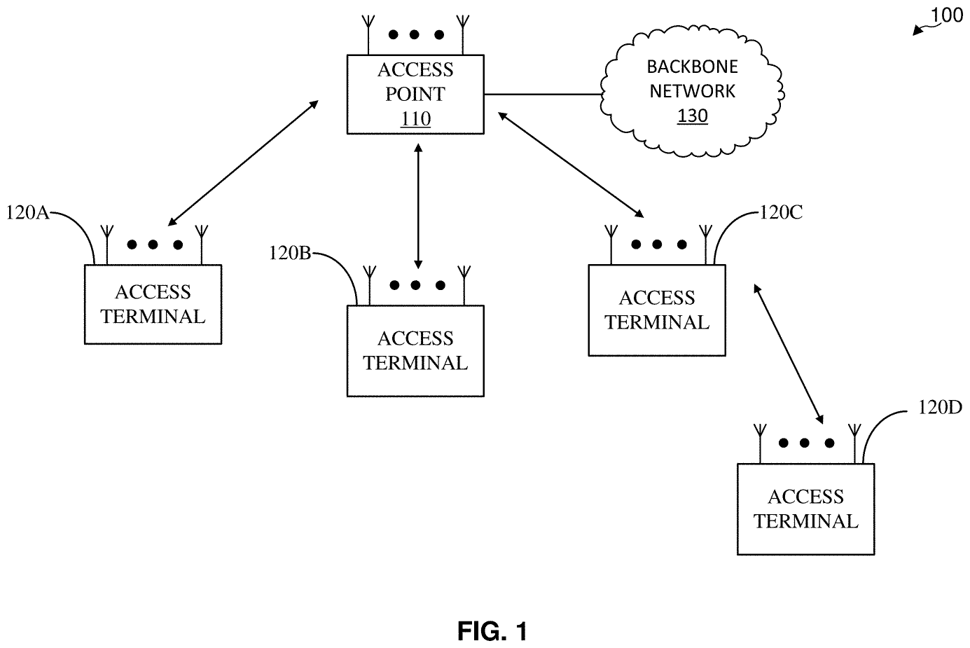

FIG. 1 illustrates an example of a wireless communication system 100 with access points and access terminals. For simplicity, only one access point 110 is shown in FIG. 1. An access point is generally a fixed station that communicates with the access terminals and may also be referred to as a base station or some other terminology. An access terminal may be fixed or mobile and may also be referred to as a mobile station, a wireless device or some other terminology. Access point 110 may communicate with one or more access terminals 120A-120C at any given moment on the downlink and uplink. The downlink (i.e., forward link) is the communication link from the access point to the access terminals, and the uplink (i.e., reverse link) is the communication link from the access terminals to the access point. An access terminal may also communicate peer-to-peer with another access terminal, such as access terminal 120C communicating with access terminal 120D via a peer-to-peer communication link. The access point 110 may be coupled to a backbone network 130 (e.g., the Internet) to provide the access terminals with access to the backbone network 130.

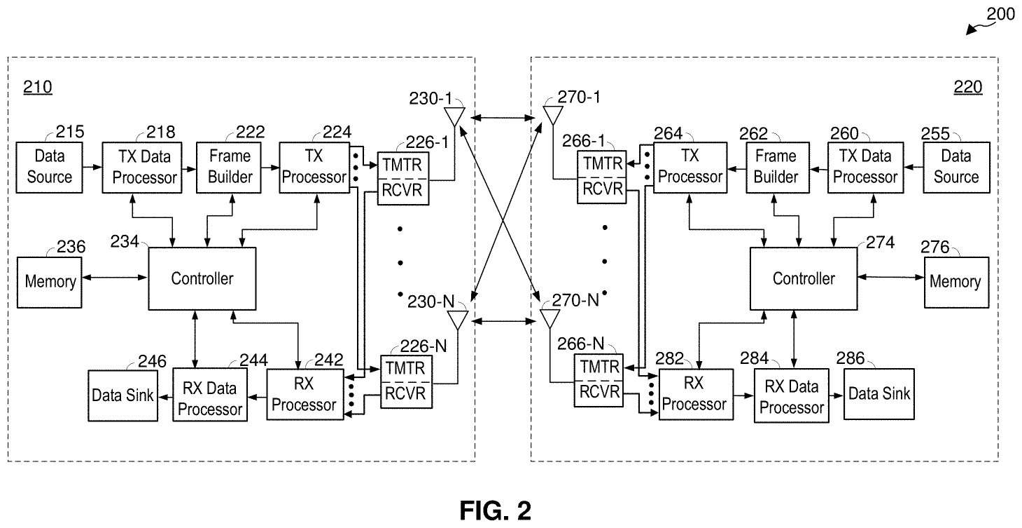

FIG. 2 illustrates a block diagram of an access point 210 (generally, a first wireless node) and an access terminal 220 (generally, a second wireless node) of a wireless communication system 200. The access point 210 is a transmitting entity for the downlink and a receiving entity for the uplink. The access terminal 220 is a transmitting entity for the uplink and a receiving entity for the downlink. As used herein, a “transmitting entity” is an independently operated apparatus or wireless node capable of transmitting data via a wireless channel, and a “receiving entity” is an independently operated apparatus or wireless node capable of receiving data via a wireless channel.

Although, in this example, wireless node 210 is an access point and wireless node 220 is an access terminal, it shall be understood that the wireless node 210 may alternatively be an access terminal, and wireless node 220 may alternatively be an access point. The wireless node 210 may be used to implement the access point 110 in FIG. 1, and the wireless node 220 may be used to implement any one of the access terminals 120A-120D in FIG. 1.

For transmitting data, the access point 210 comprises a transmit data processor 218, a frame builder 222, a transmit processor 224, a plurality of transceivers 226-1 to 226-N, and a plurality of antennas 230-1 to 230-N. The access point 210 also comprises a controller 234 configured to control operations of the access point 210, as discussed further below.

In operation, the transmit data processor 218 receives data (e.g., data bits) from a data source 215, and processes the data for transmission. For example, the transmit data processor 218 may encode the data (e.g., data bits) into encoded data, and modulate the encoded data into data symbols. The transmit data processor 218 may support different modulation and coding schemes (MCSs). For example, the transmit data processor 218 may encode the data (e.g., using low-density parity check (LDPC) encoding) at any one of a plurality of different coding rates. Also, the transmit data processor 218 may modulate the encoded data using any one of a plurality of different modulation schemes, including, but not limited to, BPSK, QPSK, 16QAM, 64QAM, 64APSK, 128APSK, 256QAM, and 256APSK.

In certain aspects, the controller 234 may send a command to the transmit data processor 218 specifying which modulation and coding scheme (MCS) to use (e.g., based on channel conditions of the downlink), and the transmit data processor 218 may encode and modulate data from the data source 215 according to the specified MCS. It is to be appreciated that the transmit data processor 218 may perform additional processing on the data such as data scrambling, and/or other processing. The transmit data processor 218 outputs the data symbols to the frame builder 222.

The frame builder 222 constructs a frame (also referred to as a packet), and inserts the data symbols into a data payload of the frame. Example frame structures or formats are discussed further below. The frame builder 222 outputs the frame to the transmit processor 224. The transmit processor 224 processes the frame for transmission on the downlink. For example, the transmit processor 224 may support different transmission modes such as an orthogonal frequency-division multiplexing (OFDM) transmission mode and a single-carrier (SC) transmission mode. In this example, the controller 234 may send a command to the transmit processor 224 specifying which transmission mode to use, and the transmit processor 224 may process the frame for transmission according to the specified transmission mode.

In certain aspects, the transmit processor 224 may support multiple-output-multiple-input (MIMO) transmission. In these aspects, the access point 210 includes multiple antennas 230-1 to 230-N and multiple transceivers 226-1 to 226-N (e.g., one for each antenna). The transmit processor 224 may perform spatial processing on the incoming frames and provide a plurality of transmit frame streams for the plurality of antennas. The transceivers 226-1 to 226-N receive and process (e.g., convert to analog, amplify, filter, and frequency upconvert) the respective transmit frame streams to generate transmit signals for transmission via the antennas 230-1 to 230-N.

For transmitting data, the access terminal 220 comprises a transmit data processor 260, a frame builder 262, a transmit processor 264, a plurality of transceivers 266-1 to 266-N, and a plurality of antennas 270-1 to 270-N. The access terminal 220 may transmit data to the access point 210 on the uplink, and/or transmit data to another access terminal (e.g., for peer-to-peer communication). The access terminal 220 also comprises a controller 274 configured to control operations of the access terminal 220, as discussed further below.

In operation, the transmit data processor 260 receives data (e.g., data bits) from a data source 255, and processes (e.g., encodes and modulates) the data for transmission. The transmit data processor 260 may support different MCSs. For example, the transmit data processor 260 may encode the data (e.g., using LDPC encoding) at any one of a plurality of different coding rates, and modulate the encoded data using any one of a plurality of different modulation schemes, including, but not limited to, BPSK, QPSK, 16QAM, 64QAM, 64APSK, 128APSK, 256QAM, and 256APSK. In certain aspects, the controller 274 may send a command to the transmit data processor 260 specifying which MCS to use (e.g., based on channel conditions of the uplink), and the transmit data processor 260 may encode and modulate data from the data source 255 according to the specified MCS. It is to be appreciated that the transmit data processor 260 may perform additional processing on the data. The transmit data processor 260 outputs the data symbols to the frame builder 262.

The frame builder 262 constructs a frame, and inserts the received data symbols into a data payload of the frame. Example frame structures or formats are discussed further below. The frame builder 262 outputs the frame to the transmit processor 264. The transmit processor 264 processes the frame for transmission. For example, the transmit processor 264 may support different transmission modes such as an OFDM transmission mode and an SC transmission mode. In this example, the controller 274 may send a command to the transmit processor 264 specifying which transmission mode to use, and the transmit processor 264 may process the frame for transmission according to the specified transmission mode.

In certain aspects, the transmit processor 264 may support multiple-output-multiple-input (MIMO) transmission. In these aspects, the access terminal 220 includes multiple antennas 270-1 to 270-N and multiple transceivers 266-1 to 266-N (e.g., one for each antenna). The transmit processor 264 may perform spatial processing on the incoming frame and provide a plurality of transmit frame streams for the plurality of antennas. The transceivers 266-1 to 266-N receive and process (e.g., convert to analog, amplify, filter, and frequency upconvert) the respective transmit frame streams to generate transmit signals for transmission via the antennas 270-1 to 270-N.

For receiving data, the access point 210 comprises a receive processor 242, and a receive data processor 244. In operation, the transceivers 226-1 to 226-N receive signals (e.g., from the access terminal 220) via the antennas 230-1 to 230-N, and process (e.g., frequency downconvert, amplify, filter and convert to digital) the received signals.

The receive processor 242 receives the outputs of the transceivers 226-1 to 226-N, and processes the outputs to recover data symbols. For example, the access point 210 may receive data (e.g., from the access terminal 220) in a frame. In this example, the receive processor 242 may detect the start of the frame using the STF sequence in the preamble of the frame. The receive processor 242 may also use the STF for automatic gain control (AGC) adjustment. The receive processor 242 may also perform channel estimation (e.g., using the CE sequence in the preamble of the frame) and perform channel equalization on the received signal based on the channel estimation.

The receive processor 242 may also recover information (e.g., MCS scheme) from the header of the frame, and send the information to the controller 234. After performing channel equalization, the receive processor 242 may recover data symbols from the frame, and output the recovered data symbols to the receive data processor 244 for further processing. It is to be appreciated that the receive processor 242 may perform other processing.

The receive data processor 244 receives the data symbols from the receive processor 242 and an indication of the corresponding MSC scheme from the controller 234. The receive data processor 244 demodulates and decodes the data symbols to recover the data according to the indicated MSC scheme, and outputs the recovered data (e.g., data bits) to a data sink 246 for storage and/or further processing.

As discussed above, the access terminal 220 may transmit data using an OFDM transmission mode or a SC transmission mode. In this case, the receive processor 242 may process the receive signal according to the selected transmission mode. Also, as discussed above, the transmit processor 264 may support multiple-output-multiple-input (MIMO) transmission. In this case, the access point 210 includes multiple antennas 230-1 to 230-N and multiple transceivers 226-1 to 226-N (e.g., one for each antenna). Each transceiver receives and processes (e.g., frequency downconverts, amplifies, filters, and converts to digital) the signal from the respective antenna. The receive processor 242 may perform spatial processing on the outputs of the transceivers 226-1 to 226-N to recover the data symbols.

For receiving data, the access terminal 220 comprises a receive processor 282, and a receive data processor 284. In operation, the transceivers 266-1 to 266-N receive signals (e.g., from the access point 210 or another access terminal) via the antennas 270-1 to 270-N, and process (e.g., frequency downconvert, amplify, filter and convert to digital) the received signals.

The receive processor 282 receives the outputs of the transceivers 266-1 to 266-N, and processes the outputs to recover data symbols. For example, the access terminal 220 may receive data (e.g., from the access point 210 or another access terminal) in a frame, as discussed above. In this example, the receive processor 282 may detect the start of the frame using the STF sequence in the preamble of the frame. The receive processor 282 may also perform channel estimation (e.g., using the CE sequence in the preamble of the frame) and perform channel equalization on the received signal based on the channel estimation.

The receive processor 282 may also recover information (e.g., MCS scheme) from the header of the frame, and send the information to the controller 274. After performing channel equalization, the receive processor 282 may recover data symbols from the frame, and output the recovered data symbols to the receive data processor 284 for further processing. It is to be appreciated that the receive processor 282 may perform other processing.

The receive data processor 284 receives the data symbols from the receive processor 282 and an indication of the corresponding MSC scheme from the controller 274. The receive data processor 284 demodulates and decodes the data symbols to recover the data according to the indicated MSC scheme, and outputs the recovered data (e.g., data bits) to a data sink 286 for storage and/or further processing.

As discussed above, the access point 210 or another access terminal may transmit data using an OFDM transmission mode or a SC transmission mode. In this case, the receive processor 282 may process the receive signal according to the selected transmission mode. Also, as discussed above, the transmit processor 224 may support multiple-output-multiple-input (MIMO) transmission. In this case, the access terminal 220 includes multiple antennas 270-1 to 270-N and multiple transceivers 266-1 to 266-N (e.g., one for each antenna). Each transceiver receives and processes (e.g., frequency downconverts, amplifies, filters, and converts to digital) the signal from the respective antenna. The receive processor 282 may perform spatial processing on the outputs of the transceivers to recover the data symbols.

As shown in FIG. 2, the access point 210 also comprises a memory 236 coupled to the controller 234. The memory 236 may store instructions that, when executed by the controller 234, cause the controller 234 to perform one or more of the operations described herein. Similarly, the access terminal 220 also comprises a memory 276 coupled to the controller 274. The memory 276 may store instructions that, when executed by the controller 274, cause the controller 274 to perform the one or more of the operations described herein.

### Addressing Actual or Anticipated Uplink Closing Issue

In a wireless communication system, a condition may arise where an access terminal (also referred to herein as a wireless station or generally as a wireless node) is having an issue communicating with an access point (also generally referred to as a wireless node) via an uplink transmission. For example, a station may be assigned a relatively wide bandwidth channel (for example, a 20 MHz, 40 MHz, or greater bandwidth channel) for communicating with an access point. If the station is sufficiently close in distance to the access point, the quality of the communication link (uplink and downlink) between the station and the access point may be sufficient that frames are successfully transmitted and received between both wireless nodes using the relatively wide bandwidth.

However, if the station moves farther away from the access point, the quality of the communication link between the station and the access point may not be sufficient for frames to be successfully transmitted between the wireless nodes using the relatively wide bandwidth. The adverse impact on the communication link is typically harsher for the uplink (from station to access point) compared to the downlink (from access point to station). This is because the transmit power of the access point is larger than that of the station. In this regard, the station is able to receive frames from the access point via the downlink, but the access point is not able to receive frames from the station via the uplink. When this condition occurs, the station is said to not be able to close the link because the station fails to receive responses to its transmitted uplink frames from the access point.

A similar scenario occurs when a station enters a low power consumption mode, for example, in response to a charge on a battery falling below a certain threshold or for any other reason. In such a low power (consumption) mode, a station may intentionally lower its maximum transmit power. So, during normal power (consumption) mode, the station is able to close the link because its maximum transmit power is set relatively high (compared to that set in the lower power mode), and is able to transmit frames with sufficient power for the access point to receive frames and transmit responses back to the station. In low power mode, the limited transmit power of the station may not be sufficient for the access point to successfully receive frames transmitted by the station. Accordingly, the station is unable to close the link.

The above link issues may be the result of the station being assigned a channel with a relatively high bandwidth. Generally, the greater the bandwidth, the lower the power spectral density of the transmit power. This is because the transmit signal is spread in frequency over a larger bandwidth, and thus, the transmit power per unit of frequency (dBm/Hz) is relatively low. As a result, the range of the transmitted signal is relatively small. In contrast, if the station were to be assigned a narrower bandwidth channel, the transmit power spectral density would increase because the transmit signal is spread in frequency over a narrower bandwidth; and thus, the transmit power per unit frequency (dBm/Hz) is relatively high. Thus, with a narrower bandwidth channel, a station may be able to extend its transmission range, allowing it to close the link with an access point.

The above link issues may adversely impact the data throughput in a wireless communication system. For example, a station may be assigned the entire available bandwidth for communication with an access point (e.g., referred to as a single user (SU) communication session). During the time that the station is assigned the entire available bandwidth, there may be other stations waiting for the channel to be available to transmit to the access point. If, during such time, the station is unable to close the link as manifested by repeatedly transmitting frames to the access point, and not getting any responses from the access point, the other stations also are not able to communicate with the access point because the channel is occupied, and thus, the data throughput of the entire wireless communication system is adversely impacted.

To address the link closure issue, a station that is experiencing difficulties closing the link or anticipates that it will experience difficulties closing the link, may send a request to the access point to be assigned a narrower bandwidth channel (also referred to herein as a sub-channel) for uplink transmission. For example, the access point may assign the station an RU allocation comprising only a subset of the tones or subcarriers of a 20 MHz channel. As discussed, the narrower bandwidth channel results in a higher transmit power spectral density, which increases the transmission range of the station. Thus, with the newly assigned narrower bandwidth channel, the station is able to close the link with the access point, and is able to receive responses to transmitted uplink frames from the access point; thereby closing the link.

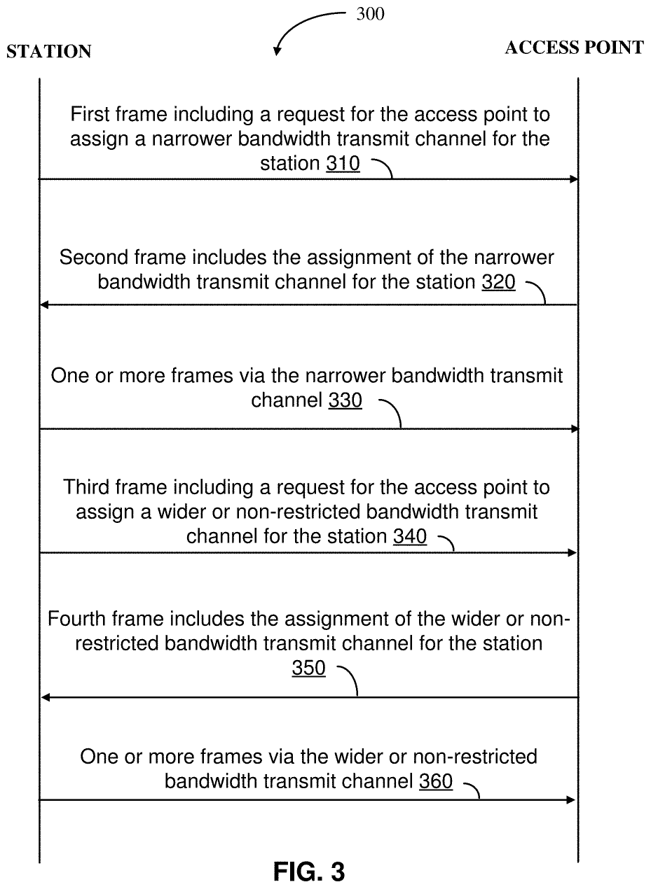

FIG. 3 illustrates an example method 300 for requesting and being assigned a different bandwidth channel in accordance with certain aspects of the present disclosure. In this example, a communication session exists between a station and an access point. Although, in this example, the communication session is between the station (access terminal) and the access point, the communication may be a peer-to-peer communication between two stations.

According to the method 300, a station transmits a first frame to an access point, wherein the first frame includes a request (including information) for the access point to assign a narrower bandwidth transmit channel for the station (block 310). As an example, the information may indicate that the station is unable to close the uplink to the access point. As discussed, a station is not able to close the uplink to the access point if it does not receive any responses, such as acknowledgements (for example, ACKs, Block ACKs or NACKs) or feedback, from the access point based on one or more uplink transmit frames.

As another example, the information in the request may indicate that the received power level of frames transmitted by the access point and received by the station has fallen below a certain power threshold. This may be the case where the station is experiencing difficulties closing the uplink to the access point or anticipates that it will experience closing the uplink to the access point. This is because the received power level of the frames received by the station may indicate that the access point is far away and the maximum transmit power of the station may not be sufficient to close the uplink to the access point now or in the future. As an additional example, the information in the request may indicate that the distance between the station and the access point is above a threshold.

As another example, the information in the request may indicate that the station is operating or will operate in a low power mode where its maximum transmit power is reduced. In such a case, the station may anticipate that its reduced maximum transmit power is not sufficient to close the uplink to the access point.

As another example, the information in the request may indicate the current uplink power headroom, which is the difference between its maximum transmit power and the transmit power used to transmit the first frame to the access point. If the uplink power headroom is large, the access point may ignore the information when it receives the first frame because it implies that the station has sufficient transmit power headroom to close the uplink to the access point. However, if the uplink power headroom falls below a certain threshold, the access point may respond to the information by assigning a narrower bandwidth channel to the station for uplink transmission, as discussed further herein. Additionally or alternatively, the information may be or include an explicit indication that the uplink power headroom has fallen below a threshold so assign the station a narrower bandwidth channel.

The above example also applies when a station has changed its mode of operation to a low power mode. As discussed, in such a low power mode, the maximum transmit power is artificially reduced. Because the uplink power headroom is related to the difference between the maximum transmit power and the current transmit power, a reduction in the maximum transmit power causes a corresponding reduction in the uplink power headroom. Thus, the information may also indicate the uplink power headroom associated with the station in the low power mode. Similarly, the information may be or include an explicit indication that the uplink power headroom has fallen below a threshold (due to the low power mode), and thus, the access point may assign a narrower bandwidth channel to the station for uplink transmission.

Referring again to FIG. 3, the method 300 further includes the access point receiving the first frame from the station, and generating and transmitting a second frame based on the information in the first frame (block 320). The second frame includes an assignment of a narrower bandwidth transmit channel to be used by the station. Further, in accordance with the method 300, the station receives the second frame including the assignment of the narrower bandwidth transmit channel, and transmits one or more frames to the access point via the narrower bandwidth transmit channel (block 330).

In some example, stations that are not able to, or anticipate not being able to, close the link may not be permitted to transmit frames using Enhanced Distributed Channel Access (EDCA). That is, an access point may signal to such stations that they are not allowed to contend for access, and that, instead, the access point will trigger uplink transmissions from these stations.

The station may in some examples continue to transmit via the narrower bandwidth transmit channel until conditions change (e.g., the station moves closer to the access point or the station enters a normal or higher power mode where it has a higher maximum transmit power). In such a case, the station may transmit a third frame including a request for the access point to assign a wider or non-restricted bandwidth transmit channel to be used by the station (block 340). The access point receives the third frame from the station, and generates and transmits a fourth frame based on the information, the fourth frame includes the assignment of the wider or non-restricted bandwidth transmit channel for the station (block 350). The station receives the fourth frame, and transmits one or more frames to the access point via the wider or non-restricted bandwidth transmit channel (block 360).

More generally, if the link condition for the station changes or is anticipated to change, the station sends a frame including information to cause the access point to assign different transmit channel parameters for the station to transmit frames to the access point. As discussed above, the different channel parameters may specify a channel assignment or RU allocation having a different bandwidth than a normal operating bandwidth. However, the different channel parameters also may specify other channel parameters, such as a different modulation and coding scheme (MCS) or a different frame format, such as a single user (SU) frame format versus a multiple user (MU) frame format. Although the examples described below relate to a change in the channel bandwidth, it shall be understood that it can relate to a change in any one or more channel parameters.

Techniques for addressing communication link issues will now be discussed with reference to a more detail implementation with reference to a wireless communication system complying with the Institute of Electrical and Electronic Engineers (IEEE) 802.11ax communication protocol. However, it shall be understood that the above method may be implemented in any wireless communication system configured to comply with another protocol or standard.

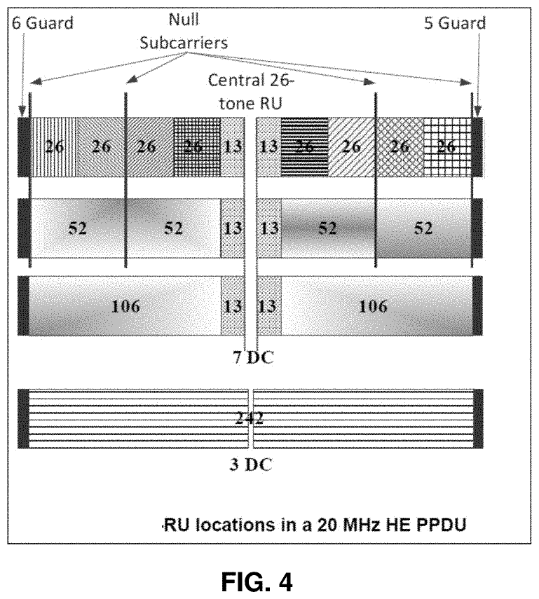

FIG. 4 illustrates a diagram of defined channels or sub-channels, for example, in the form of resource units (RUs) for wireless communication between at least two wireless nodes in accordance with certain aspects of the present disclosure. The transmission and reception of frames in accordance with 802.11ax may be accomplished via an orthogonal frequency division multiplexing (OFDM) modulation scheme. In an OFDM scheme, information in frames are transmitted and received in parallel via a set of orthogonal subcarriers or tones. Each subcarrier has substantially the same frequency bandwidth.

The entire available subcarriers of an OFDM transmission may be assigned to a single station (or access point) for a single user (SU) transmission or reception session. Thus, in such case, the single station transmits or receives in parallel the information in frames via the entire set of available subcarriers. For multiple access purposes, the entire available subcarriers may be subdivided into sets of defined subcarriers, referred to as RUs, for assignment to different stations for a multiple user (MU) transmission or reception session. Thus, in such case, each station transmits or receives in parallel the information in frames via its assigned RU.

The diagram depicted in FIG. 4 illustrates an example definition of OFDM subcarriers and assignments of the subcarriers to RUs. This example is for a case where the bandwidth of the OFDM communication session is 20 MHz. It shall be understood that the bandwidth, subcarrier definitions, and RU definitions may vary per assigned frequency band (e.g., 2.4 GHz, 5 GHz, 60 GHz, etc.) and country or region in which the wireless communication system is deployed.

The horizontal axis of the diagram represents a frequency or subcarrier index. There are four rows each indicating a different transmission or reception configuration. For example, the bottom row represents a single user (SU) transmission or reception configuration where the entire available set of subcarriers is assigned to a single user. In this example, the SU configuration includes 242 data subcarriers, 3 DC subcarriers, a low frequency guard of 6 subcarrier width, and a high frequency guard of 5 subcarrier width. The data subcarrier range below the DC subcarriers in frequency have an index range of −122 to −2, and the data subcarrier range above the DC subcarriers in frequency have an index range of +2 to +122. The 3 DC subcarriers are indexed as −1, 0, +1. Thus, a station performing an SU OFDM transmission or reception has 242 subcarriers via which it can transmit or receive frames. In this example, there is a single RU consisting of subcarriers −122 to −2 and +2 to +122, which could be identified as RU-1 of an SU session.

The second row from the bottom represents a multiple user (MU) Orthogonal Frequency Division Multiple Access (OFDMA) configuration for two users (referred to herein as MU-2) where the entire OFDM subcarriers is subdivided into 2 RUs. A first RU (below the DC subcarriers in frequency) has a subcarrier index range of −122 to −17. A second RU (above the DC subcarriers in frequency) has a subcarrier index range of +17 to +122. The DC subcarriers having an index range of −3 to +3. There is a spacing of 13 subcarriers between the first RU and lowest frequency DC subcarrier, and there is also another spacing of 13 subcarriers between the highest frequency DC subcarrier and the second RU. The same low and high frequency guards are present in this MU-2 configuration. Thus, a first station may be assigned to transmit or receive via the first RU (which may be identified as RU-1) and a second station may be assigned to simultaneously transmit or receive via the second RU (which may be identified as RU-2).

The third from the bottom represents a multiple user (MU) OFDMA configuration for four users (referred to herein as MU-4) where the entire OFDM subcarriers are subdivided into 4 RUs. A first RU (below the DC subcarriers in frequency) has a subcarrier index range of −122 to −71. A second RU (also below the DC subcarriers and above the first RU in frequency) has a subcarrier index range of −68 to −17. There are 3 null subcarriers between the first and second RUs. The DC subcarriers have an index range of −3 to +3. There is a spacing of 13 subcarriers between the second RU and lowest frequency DC subcarrier.

A third RU (above the DC subcarriers in frequency) has a subcarrier index range of +17 to +68. A fourth RU (also above the DC subcarriers and also the third RU in frequency) has a subcarrier index range of +71 to +122. There are 3 null subcarriers between the first and second RUs. There is also a spacing of 13 subcarriers between the highest frequency DC subcarrier and the third RU. There are 3 null subcarriers between the third and fourth RUs. The same low and high frequency guards are present in the MU-4 configuration. Thus, a first station may be assigned to simultaneously or separately transmit or receive via the first RU (which may be identified as RU-1), a second station may be assigned to simultaneously transmit or receive via the second RU (which may be identified as RU-2), a third station may be assigned to simultaneously or separately transmit or receive via the third RU (which may be identified as RU-3), and a fourth station may be assigned to simultaneously transmit or receive via the fourth RU (which may be identified as RU-4).

The top row represents an MU OFDMA configuration for eight (8) users (referred to herein as an MU-8) where the OFDM subcarriers are subdivided into 8 RUs each having 26 subcarriers (e.g., RU-1 to RU-8, from lowest to highest in frequency). The MU-8 configuration includes DC subcarriers definition, null subcarriers definition, and guards definition as indicated, similar to as discussed above in detail with respect to the SU, MU-2, and MU-4 configurations. Thus, 8 stations may simultaneously transmit or receive frames in parallel via RUs 1-8, respectively. However, in some cases, a standard or protocol may limit the maximum number of stations in an MU OFDMA configuration to be less than the number of available RUs for that configuration. For example, in the MU-8 OFDMA configuration, the standard or protocol may limit the configuration to only 7 stations that can simultaneously transmit or receive, even though there are 8 available RUs.

In the above example, the RUs are symmetrical about the subcarrier index 0. However, it shall be understood that the RU definition need not be symmetrical about the subcarrier index 0. For example, an MU RU assignment may have two 52-subcarrier RUs below the DC subcarriers in frequency and four 26-subcarriers RUs above the DC subcarriers in frequency. Other asymmetrical RU definitions are possible depending on the application.

Now tying the diagram of FIG. 4 with the method of addressing an actual or anticipated closing a link issue, a station may have been assigned RU-1 associated with an SU configuration, which occupies 242 subcarriers and substantially the entire 20 MHz band for transmission. However, as discussed, the station may not be able to close the link with the access point while being assigned RU-1 of the SU transmission. Thus, the station sends a frame with the information concerning the actual or anticipated closing the link issue to the access point. In response, the access point sends a frame to the station assigning a narrower bandwidth channel for transmission of uplink frames. For example, the access point may assign RU-1 (106 subcarriers) of the MU-2 configuration (second row from the bottom in FIG. 4). Because RU-1 of the MU-2 configuration has a bandwidth smaller than RU-1 of the SU transmission (106 subcarriers versus 242 subcarriers), the station may be able to close the link with the access point. In this example, the access point may assign RU-2 of MU-2 transmission to a different station for simultaneous transmission with the station-of-interest.

The method also applies when the station is initially transmitting uplink frames via RU-1 of the MU-2 configuration, and is experiencing link closure issues or anticipates that it will experience link closure issue. In response, the station sends a frame including information that will cause the access point to assign a narrower bandwidth channel to the station for uplink transmission. In such case, the access point may assign RU-3 (52 subcarriers) of the MU-4 configuration or RU-4 (26 subcarriers) of the MU-8 configuration. As these RUs are narrower in bandwidth than RU-1 of MU-2 transmission, the station may be able to close the link with the access point. Similarly, the access point may assign other stations available RUs in MU-4 or MU-8 for simultaneous transmission with the station-of-interest.

The following discussion concerns how an access point may assign a different channel or RU to a station requesting a narrower bandwidth channel due to a link closure issue. There are two general methods by which an access point may assign a narrower bandwidth RU to a requesting station. A first method utilizes a trigger frame and a second method utilizes a downlink data or control frame.

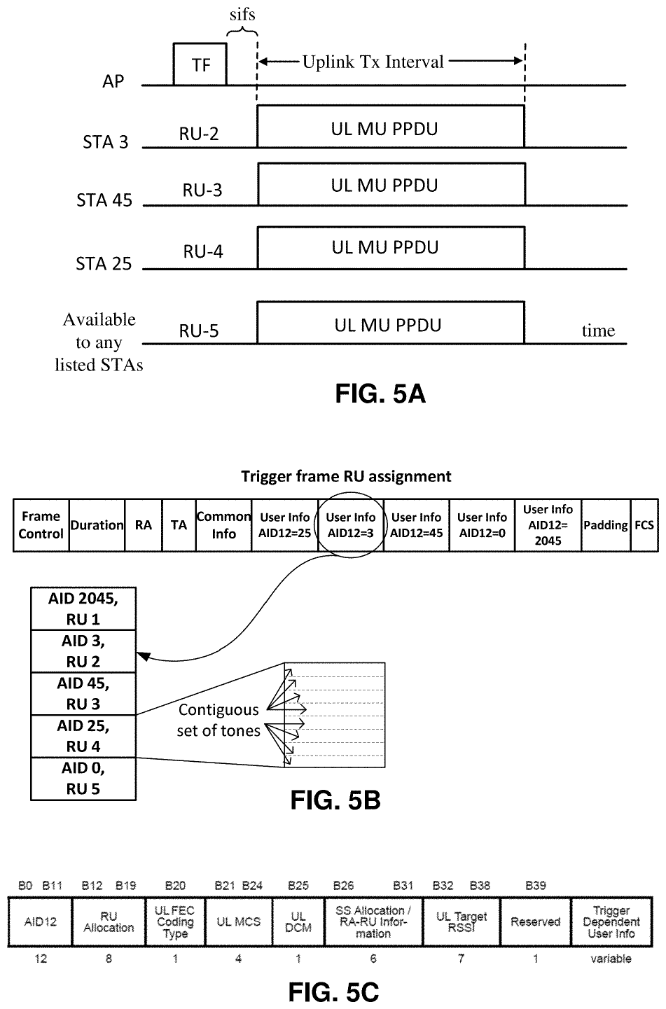

FIG. 5A illustrates a timing diagram of an example trigger-based uplink communication session including RU allocation for each station to use in transmitting responsive uplink frames to an access point in accordance with certain aspects of the present disclosure. The horizontal axis represents time. The top row of the diagram concerns the transmission of an access point (AP) for assigning RUs to different stations. The second row (from the top) concerns the transmission of station 3. The third row (from the top) concerns the transmission of station 45. And, the fourth row (from the top) concerns the transmission of station 25. The bottom row concerns a random access (RA) RU, which is a common channel accessible via contention by any of the stations identified in a trigger frame for use in transmitting to the access point, which may be in addition to a station's assigned RU.

According to the timing diagram, the access point transmits a trigger frame (TF) to allocate RUs and other parameters and provide information (e.g., a modulation coding scheme (MCS), a length of the uplink transmission interval, among other useful information) to different stations for them to perform the triggered uplink transmission. Thus, the trigger frame (TF) is referred to as a scheduling control frame for controlling the uplink transmission by the indicated stations. As the parameter of interest is the assignment of the RUs, the access point, via a trigger frame (TF), has assigned RU-2 to station 3, RU-3 to station 45, and RU-4 to station 25. Further, in this example, RU-5 is a random access (RA) RU, which is a common channel available to the indicated stations (e.g., stations 3, 25, and 45 or other stations) for use in transmitting additional frames to the access point.

After the stations have received the trigger frame (TF), there is a short interframe space (SIFS) between the trigger frame (TF) and an uplink transmission interval. During this time, the stations 3, 45, and 25 configure their respective transmitters for transmission of frames via RU-2, RU-3, and RU-4, respectively. After the SIFS, the stations 1, 45 and 25 simultaneously transmit their respective frames to the access point via RU-2, RU-3, and RU-4, respectively. The transmitted frames may be referred to collectively as an uplink (UL) multiple user (MU) physical layer convergence procedure (PLCP) protocol data unit (PPDU) (UL MU PPDU).

FIG. 5B illustrates a diagram of an example trigger frame (TF) in accordance with certain aspects of the present disclosure. Again, the trigger frame (TF) is specified in detail in the 802.11ax protocol. The trigger frame (TF) includes a frame control field, duration field, receiver address (RA) field, transmitter address (TA) field, common information field, user information field for identified station 25 (AID12=25), user information field for identified station 3 (AID12=3), user information field for identified station 45 (AID12=45), a field for identifying the associated station RA RU (AID=0), a field for identifying an unassociated station RA RU (AID=2045), padding, and a frame check sequence (FCS).

The RU assignment for the different stations are identified in the user information fields pertaining to the different stations. For example, as indicated, station 3 has been assigned RU-2, station 45 has been assigned RU-3, and station 25 has been assigned RU-4. As shown, the trigger frame (TF) may also assign an RU for the associated or unassociated stations for random access (RA) use. For example, the trigger frame (TF) has assigned RU-1 for use by unassociated stations to transmit to the access point. The trigger frame may optionally assign RU-5, which is a common channel available for associated stations (e.g., stations 3, 45, and 25), to transmit additional frames to the access point. As discussed further herein, the associated RA RU may optionally be used by a station to send a frame to the access point with information triggering an assignment of a narrower bandwidth RU.

FIG. 5C illustrates a diagram of an example user information field of a trigger frame in accordance with certain aspects of the present disclosure. Again, the user information field is specified in detail in the 802.11ax protocol. As illustrated, the user information field includes a station identification subfield AID12, an RU allocation subfield, an uplink (UL) frame error correction (FEC) coding type subfield, an uplink (UL) dual carrier modulation (DCM) subfield, a spatial stream (SS) Allocation/RA-RU information subfield, an uplink target RSSI subfield, a reserved subfield, and a trigger dependent user information subfield. The RU identified in the RU Allocation subfield is assigned to the station identified in the station identification subfield AID12.

Now tying the diagrams of FIGS. 5A-5C with the method of addressing an actual or anticipated closing a link issue, a station, such as station 3, may have been assigned an RU (e.g., RU-1 (242 subcarriers) of an SU transmission) that is causing or expected to cause uplink closure issues prior to receiving the trigger frame (TF) from the access point as depicted in FIG. 5A. Also prior to receiving the trigger frame (TF), station 3 has transmitted a frame to the access point with information (for example, included within a request) that causes the access point to assign a narrow bandwidth RU to station 3. Accordingly, the trigger frame (TF) depicted in FIG. 5A assigns RU-2 of an MU-4 OFDMA configuration, which has a bandwidth of 52 subcarriers (less than the bandwidth of RU-1 of an SU transmission which has 242 subcarriers). The narrower bandwidth RU allows station 3 to transmit a greater distance as discussed, thereby allowing station 3 to close the uplink with the access point.

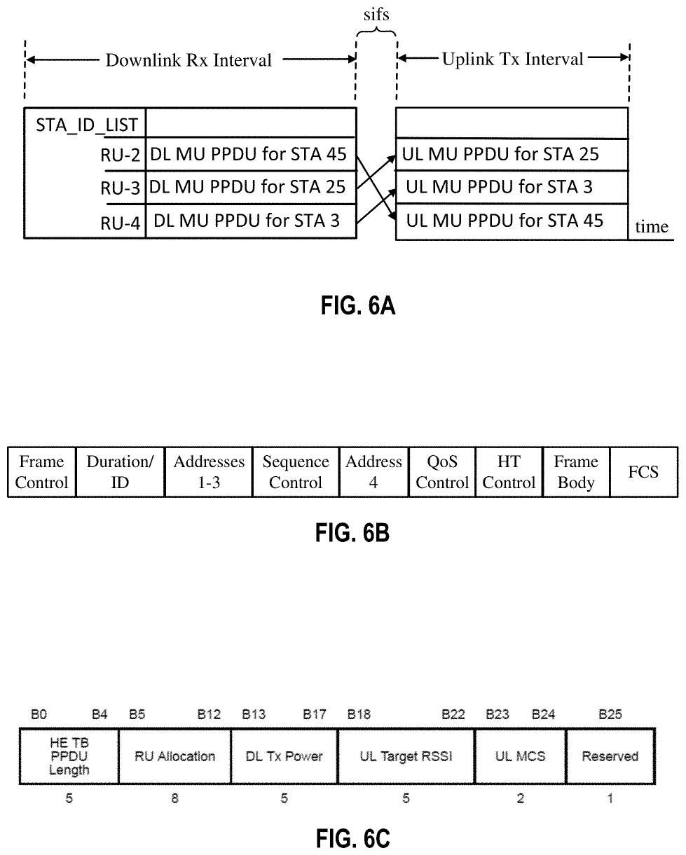

FIG. 6A illustrates a timing diagram of an example downlink communication session with a responsive uplink communication session in accordance with certain aspects of the present disclosure. In addition to a trigger frame (TF), an access point may assign RUs to different stations via a downlink frame, which is referred to as a downlink (DL) multiple user (MU) PPDU (DL MU PPDU). The horizontal axis in the timing diagram represents time.

A downlink frame includes a header portion called a station identification list (STA_ID_LIST) for common reception by all identified stations. The STA_ID_LIST identifies the target stations for the downlink frame (e.g., stations 3, 25, and 45) and also assigns RUs for receiving individual downlink frames from the access point, respectively. For instance, in this example, the STA_ID_LIST header portion assigned RU-2 to station 45, RU-3 to station 25, and RU-4 to station 3. After receiving the STA_ID_LIST header portion, the stations 45, 25, and 3 configure their receivers for simultaneous receiving of frames (e.g., DL MU PPDU) from the access point individually addressed to the stations 45, 25, and 3, respectively. Thus, during a downlink receive interval, the stations 45, 25, and 3 have received frames individually addressed to them, respectively.

Each of the individual frames provides an RU assignment for the corresponding station to use for transmitting a response to the received frame. For example, the frame (DL MU PPDU) for station 45 has assigned RU-4 for transmitting a responsive uplink frame (UL MU PPDU) to the access point. Similarly, the frame (DL MU PPDU) for station 25 has assigned RU-2 for transmitting a responsive uplink frame (UL MU PPDU) to the access point. In a similar manner, the frame (DL MU PPDU) for station 3 has assigned RU-3 for transmitting a responsive uplink frame (UL MU PPDU) to the access point. Each of the individual downlink frames also provides other parameters and information (e.g., assigned MCS, length of uplink transmit interval, etc.) to allow the stations to effectively perform the following uplink transmission.

As illustrated in FIG. 6A, after a SIFS interval from the end of the downlink frame, the stations 25, 3, and 45 simultaneous transmit their respective uplink frames to the access point via RU-2, RU-3, and RU-4 during the uplink transmit interval, respectively. As discussed below, each of the individual downlink frames (DL MU PPDU) provides an RU assignment for the corresponding station.

FIG. 6B illustrates a diagram of an example data or control frame, such as the DL MU PPDU (or UL MU PPDU) in accordance with certain aspects of the present disclosure. The frame includes a Frame Control field, a Duration/ID, three address fields 1-3, a Sequence control field, another address field 4, a Quality of Service (QoS) control field, high throughput (HT) control field, a frame body, and a frame check sequence (FCS). The details of these fields are discussed in the 802.11ax protocol. As discussed below, the HT control field includes a triggered response scheduling (TRS) subfield for assigning an RU and other parameters to the corresponding station for transmitting a responsive uplink frame. If the frame is a data frame, the payload data, which may have a variable length, is situated in the frame body.

FIG. 6C illustrates a diagram of an example triggered response scheduling (TRS) subfield of the HT control field of the data or control frame in accordance with certain aspects of the present disclosure. The TRS subfield includes a high efficiency (HE) trigger-based (TB) PPDU length sub-subfield for setting the length of the uplink transmission interval, an RU allocation sub-subfield, a downlink (DL) transmit (Tx) Power sub-subfield, an uplink (UL) target RSSI sub-subfield, an uplink MCS sub-subfield, and a reserved sub-subfield. It is in the RU allocation sub-subfield of the TRS where the corresponding station receives its RU assignment for transmitting an uplink responsive frame. The uplink MCS sub-subfield informs the station which MCS to use for the transmission. The DL Tx Power and UL target RSSI sub-subfields are for use by the station to set its transmit power such that the power of the frames received by the access point by all transmitting stations is substantially the same.

Now tying the diagrams of FIGS. 6A-6C with the method of addressing an actual or anticipated link closure issue, a station, such as station 45, may have been assigned an RU (e.g., RU-1 (242 subcarriers) of an SU configuration) that is causing or expected to cause uplink closure issues prior to receiving the downlink frame from the access point as depicted in FIG. 6A. Also prior to receiving the downlink frame, station 45 has transmitted a frame to the access point with information that causes the access point to assign a narrower bandwidth RU to station 45.

Accordingly, the individual frame (DL MU PPDU) for station 45, via its TRS field, assigns RU-4 of an MU-4 configuration to the station 45, which has a bandwidth of 52 subcarriers (less than the bandwidth of RU-1 of an SU transmission). The narrower bandwidth RU allows station 45 to transmit a greater distance as discussed, thereby allowing station 45 to close the uplink with the access point.

Now with reference to the transmission of the frame with information (for example, a request) configured to cause an access point to assign a narrower bandwidth RU, a station may transmit the frame (UL MU PPDU) to the access point via the currently assigned and dedicated RU. However, because the station may be experiencing link closure issue, such frame may not be received by the access point. As such, the station 45 may transmit the frame via a RA RU that has a narrower bandwidth than the assigned RU, allowing the station to successfully transmit the frame to the access point. The following describes a couple of examples where the information may be situated in an uplink frame (UL MU PPDU).

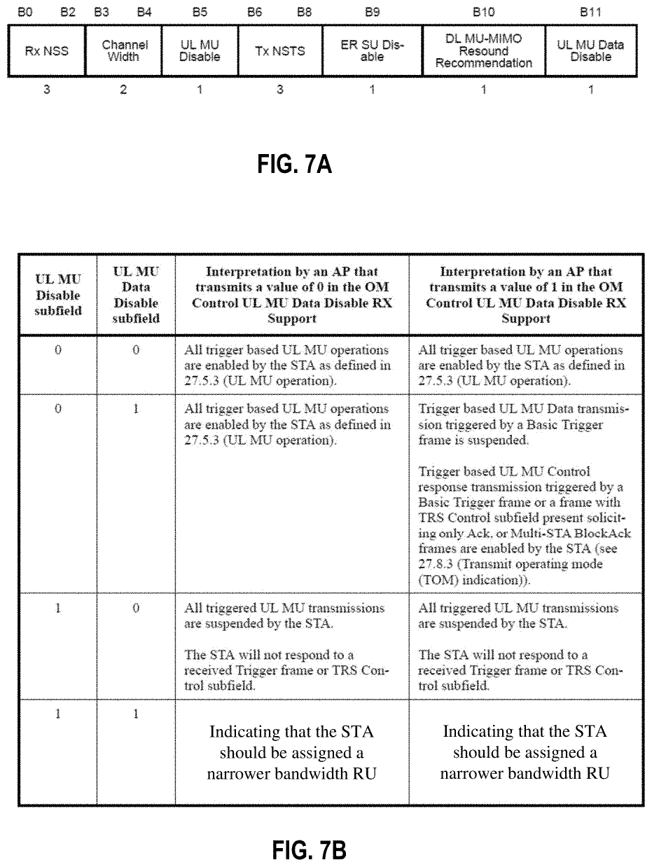

FIG. 7A illustrates a diagram of an example operation mode (OM) sub-subfield of a data or control frame in accordance with certain aspects of the present disclosure. The OM sub-subfield is situated within the A-Control subfield of an HE variant of the HT control field. The OM sub-subfield or field for ease of referencing it, includes various subfields, such as the receiver number of spatial streams (Rx NSS), Channel Width, uplink multiple user Disable (UL MU Disable), the transmitter number of spatial streams (Tx NSTS), extended range single user (ER SU) Disable, downlink (DL) MU-MIMO Resound Recommendation, and the uplink multiple user (UL MU) Data Disable. Of interest herein are the UL MU Disable and UL MU Data Disable subfields.

FIG. 7B illustrates a table of values and associated meanings of example UL MU Disable and Data Disable subfields in accordance with certain aspects of the disclosure. According to the table, if the bit values of the UL MU Disable and UL MU Data Disable subfields are 00, the station is informing the access point that it is able to perform all trigger-based uplink multiple user transmission and trigger-based uplink multiple user data transmissions. If the bit values are 01, the station is informing the access point that it is able to perform trigger-based uplink multiple user transmission but not trigger based uplink multiple user data transmissions. If the bit values are 10, the station is informing the access point that it is neither able to perform trigger-based uplink multiple user transmission nor trigger based uplink multiple user data transmissions.

In the current revision of the 802.11ax standard, the bit values 11 of the UL MU Disable and UL MU Data Disable subfields are reserved. However, as depicted in the table, the bit values 11 indicates to an access point that the station should be assigned a narrower bandwidth RU for actual or anticipated link closure purposes. Thus, when a station is having uplink closure issues or anticipates that it will have uplink closure issues, the station sets the bit values of the UL MU Disable and UL MU Data Disable subfields to 11 to inform the access point that it should assign a narrower bandwidth RU for link closure purpose. Once the wireless environment for the station has changed and the link closure issue is no longer relevant, the station may change the bit values of the UL MU Disable and UL MU Data Disable subfields to something other than 11, which may inform the access point that it is no longer having link closure issues. In such case, the access point may assign a wider bandwidth RU to the station.

Another mechanism for communicating the information concerning an actual or anticipated link closure issue to the access point is to include the information in an uplink power headroom field (UPH) of a data or control frame. The UPH field informs the access point of the current power headroom concerning the transmitted frame. The power headroom is the difference between the maximum transmit power specified for the station and the transmit power of the frame being transmitted. If the power headroom falls below a certain threshold, indicating that the station may be close to having a link closure issue, the access point may unilaterally assign a narrower bandwidth RU.

The power headroom is also a function of the operation mode of the station. For example, the station may operate in a low power mode to save battery life or for some other reason. In such low power mode, the station may artificially lower the maximum transmit power. Because the power headroom is the difference between the maximum transmit power and the transmit power for the frame being transmitted, the power headroom is typically reduced when the station enters a lower power mode. In such case, if the power headroom falls below a certain threshold, indicating that the station may be close to having a link closure issue, the access point may unilaterally assign a narrower bandwidth RU.

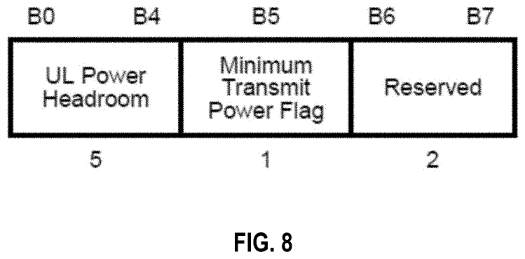

FIG. 8 illustrates a diagram of an example uplink power headroom (UPH) subfield of the high throughput (HT) control field of the data or control frame in accordance with certain aspects of the disclosure. The UPH subfield includes an uplink (UL) Power Headroom for specifying the power headroom, a Minimum Transmit Power Flag to indicate whether the minimum transmit power is reached by the station, and a reserved field. Thus, as discussed above, the information in the frame for causing the access point to assign a narrower bandwidth RU to the station may be the power headroom specified in the UL Power Headroom subfield.

Alternatively, or in addition to, the station may assert a bit in the Reserved subfield of the UPH field to inform the access point that it is having or anticipates having link closure issues. In response to the asserted bit, the access point sends a frame (e.g., trigger frame or downlink frame) to the station assigning a narrower bandwidth RU.

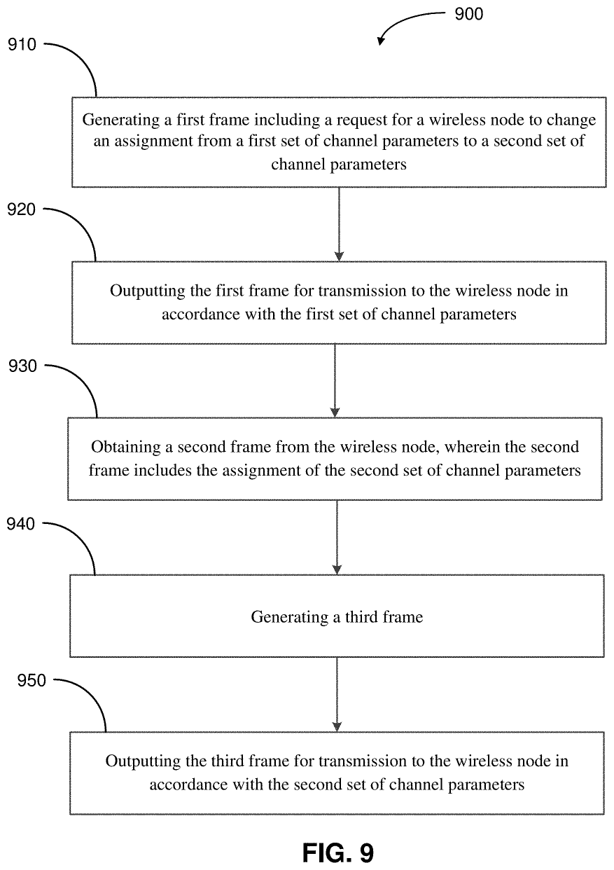

FIG. 9 shows an example method 900 for wireless communications according to certain aspects of the present disclosure. The method may be implemented by any wireless node, such as an access terminal.

The method 900 comprises generating a first frame including information configured to cause a wireless node to change an assignment from a first set of channel parameters to a second set of channel parameters (block 910). The method 900 further comprises outputting the first frame for transmission to the wireless node in accordance with the first set of channel parameters (block 920). The method 900 additionally comprises obtaining a second frame from the wireless node, wherein the second frame includes the assignment of the second set of channel parameters (block 930). The method 900 also comprises generating a third frame (block 940). And, the method 900 further comprises outputting the third frame for transmission to the wireless node in accordance with the second set of channel parameters (block 950).

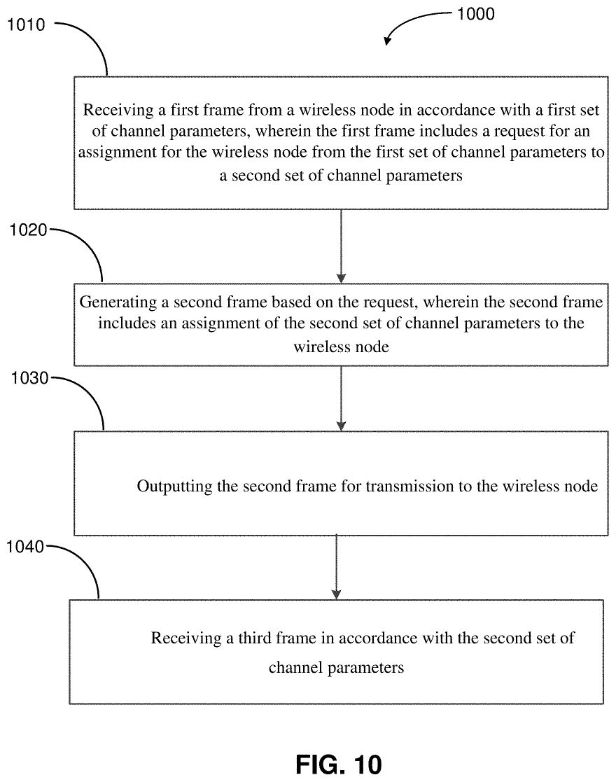

FIG. 10 shows another example method 1000 for wireless communications according to certain aspects of the present disclosure. The method 1000 may be implemented by any wireless node, such as an access point or an access terminal.

The method 1000 comprises receiving a first frame from a wireless node in accordance with a first set of channel parameters, wherein the first frame includes information for causing an assignment for the wireless node from the first set of channel parameters to a second set of channel parameters (block 1010). The method 1000 further comprises generating a second frame based on the information, wherein the second frame includes an assignment of the second set of channel parameters to the wireless node (block 1020). Additionally, the method 1000 comprises outputting the second frame for transmission to the wireless node (block 1030). And, the method 1000 further comprises receiving the third frame in accordance with the second set of channel parameters (block 1040).

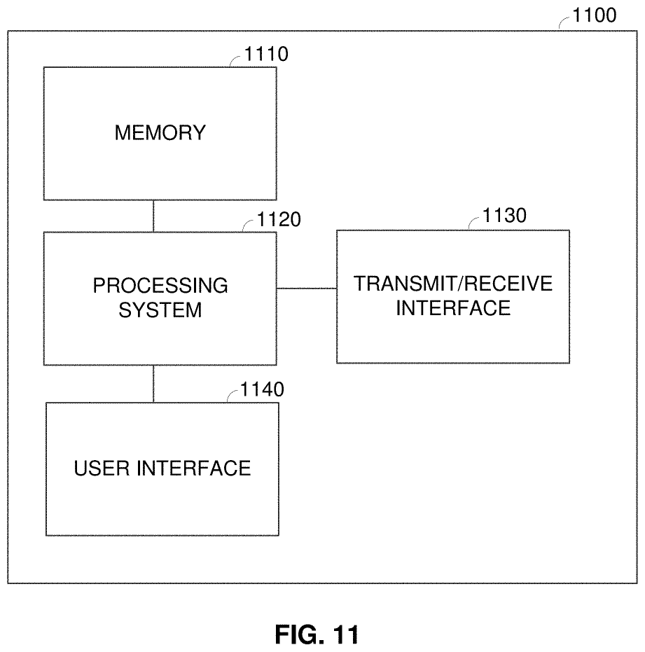

FIG. 11 illustrates an example device 1100 according to certain aspects of the present disclosure. The device 1100 may be configured to operate in a wireless node (e.g., access point 210 or access terminal 220) and to perform one or more of the operations described herein.

The device 1100 includes a processing system 1120, and a memory 1110 coupled to the processing system 1120. The memory 1110 may store instructions that, when executed by the processing system 1120, cause the processing system 1120 to perform one or more of the operations described herein. Example implementations of the processing system 1120 are provided below. The device 1100 also comprises a transmit/receive interface 1130 coupled to the processing system 1120. The transmit/receive interface 1130 (e.g., interface bus) may be configured to interface the processing system 1120 to a radio frequency (RF) front end (e.g., transceivers 226-1 to 226-N or 226-1 to 266-N).

In certain aspects, the processing system 1120 may include one or more of the following: a transmit data processor (e.g., transmit data processor 218 or 260), a frame builder (e.g., frame builder 222 or 262), a transmit processor (e.g., transmit processor 224 or 264) and/or a controller (e.g., controller 234 or 274) for performing one or more of the operations described herein.

In the case of an access terminal 220, the device 1100 may include a user interface 1140 coupled to the processing system 1120. The user interface 1140 may be configured to receive data from a user (e.g., via keypad, mouse, joystick, etc.) and provide the data to the processing system 1120. The user interface 1140 may also be configured to output data from the processing system 1120 to the user (e.g., via a display, speaker, etc.). In this case, the data may undergo additional processing before being output to the user. In the case of an access point 210, the user interface 1140 may be omitted.

Examples of means for generating a first frame including information configured to cause a wireless node to change an assignment from a first set of channel parameters to a second set of channel parameters, may include at least one of the controller 234 or 274, the frame builder 222 or 262, or the processing system 1120. Examples of means for outputting the first frame for transmission to the wireless node in accordance with the first set of channel parameters may include at least one of the transmit processor 224 or 264, the transceivers 226-1 to 226-N or 266-1 to 266-N, or the transmit/receive interface 1130. Examples of means for obtaining a second frame from the wireless node, wherein the second frame includes the assignment of the second set of channel parameters, may include at least one of the controller 234 or 274, receive processor 242 or 282, receive data processor 244 or 282, or the processing system 1120. Examples of means for generating a third frame may include at least one of the controller 234 or 274, the frame builder 222 or 262, or the processing system 1120. Examples of means for outputting the third frame for transmission to the wireless node in accordance with the second set of channel parameters may include at least one of the transmit processor 224 or 264, the transceivers 226-1 to 226-N or 266-1 to 266-N, or the transmit/receive interface 1130.

Examples of means for generating one or more frames prior to generating the first frame may include at least one of the controller 234 or 274, the frame builder 222 or 262, or the processing system 1120. Examples of means for outputting the one or more frames for transmission to the wireless node in accordance with the first set of channel parameters, wherein the information is based on whether the wireless node received the one or more frames may include at least one of the transmit processor 224 or 264, the transceivers 226-1 to 226-N or 266-1 to 266-N, or the transmit/receive interface 1130. Examples of means for generating the information based on not obtaining a response from the wireless node indicating that the wireless node received the one or more frames may include at least one of the controller 234 or 274, the processing system 1120, or the user interface 1140. Examples of means for obtaining a response from the wireless node, and means for generating the information based on obtaining the response indicating that the wireless node received the one or more frames may include at least one of the controller 234 or 274, receive processor 242 or 282, receive data processor 244 or 282, or the processing system 1120.

Examples of means for obtaining one or more frames from the wireless node prior to generating the first frame may include at least one of the controller 234 or 274, receive processor 242 or 282, receive data processor 244 or 282, or the processing system 1120. Examples of means for determining a received power associated with the one or more frames may include at least one of the controller 234 or 274, the processing system 1120, or the user interface 1140. Examples of means for generating the information based on the received power of the one or more frames may include at least one of the controller 234 or 274, the processing system 1120, or the user interface 1140. Examples of means for changing a mode of operation may include at least one of the controller 234 or 274, the processing system 1120, or the user interface 1140. Examples of means for generating the information based on the change in the mode of operation may include at least one of the controller 234 or 274, the processing system 1120, or the user interface 1140.

Examples of means for generating the information based on a difference between a maximum transmit power and a transmit power associated with the first frame may include at least one of the controller 234 or 274, the processing system 1120, or the user interface 1140. Examples of means for changing a mode of operation from a first power consumption mode to a second power consumption mode may include at least one of the controller 234 or 274, the processing system 1120, or the user interface 1140. Examples of means for generating the information based on a difference between a maximum transmit power associated with the second power consumption mode and a transmit power associated with the first frame may include at least one of the controller 234 or 274, the processing system 1120, or the user interface 1140.

Examples of means for receiving a first frame from a wireless node in accordance with a first set of channel parameters, wherein the first frame includes information for causing an assignment for the wireless node from the first set of channel parameters to a second set of channel parameters, may include at least one of the transmit processor 224 or 264, the transceivers 226-1 to 226-N or 266-1 to 266-N, or the transmit/receive interface 1130. Examples of means for generating a second frame based on the information, wherein the second frame includes an assignment of the second set of channel parameters to the wireless node may include at least one of the controller 234 or 274, the frame builder 222 or 262, or the processing system 1120. Examples of means for outputting the second frame for transmission to the wireless node may include at least one of the transmit processor 224 or 264, the transceivers 226-1 to 226-N or 266-1 to 266-N, or the transmit/receive interface 1130. Examples of means for receiving a third frame in accordance with the second set of channel parameters may include at least one of the transmit processor 224 or 264, the transceivers 226-1 to 226-N or 266-1 to 266-N, or the transmit/receive interface 1130.

Examples of means for generating one or more frames may include at least one of the controller 234 or 274, the frame builder 222 or 262, or the processing system 1120. Examples of means for outputting the one or more frames for transmission to the wireless node, wherein the information is based on the received power of the one or more frames at the wireless node may include at least one of the transmit processor 224 or 264, the transceivers 226-1 to 226-N or 266-1 to 266-N, or the transmit/receive interface 1130.

It is to be understood that the present disclosure is not limited to the terminology used above to describe aspects of the present disclosure. For example, a packet may also be referred to as a frame.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system (e.g., the processing system 1120) in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of an access terminal 220 (see FIG. 2), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof.

In a hardware implementation, the machine-readable media may be part of the processing system separate from the processor. However, as those skilled in the art will readily appreciate, the machine-readable media, or any portion thereof, may be external to the processing system. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise tangible computer-readable media. Combinations of the above should also be included within the scope of computer-readable media.

Further, it should be appreciated that modules and/or other appropriate means for performing the methods and techniques described herein can be downloaded and/or otherwise obtained by an access terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that an access terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
a processing system configured to:
generate a first frame including a request to change an assignment for the apparatus from a first set of channel parameters to a second set of channel parameters; and
generate a second frame; and
an interface configured to:
output the first frame for transmission to a wireless node in accordance with the first set of channel parameters;
obtain a third frame from the wireless node, wherein the third frame includes the assignment of the second set of channel parameters; and
output the second frame for transmission to the wireless node in accordance with the second set of channel parameters.

2. The apparatus of claim 1, wherein the first set of channel parameters specifies a first bandwidth, wherein the second set of channel parameters specifies a second bandwidth, and wherein the first bandwidth is different than the second bandwidth.

3. The apparatus of claim 1, wherein the processing system is configured to generate one or more frames prior to generating the first frame, wherein the interface is configured to output the one or more frames for transmission to the wireless node in accordance with the first set of channel parameters, and the request is based on not receiving an acknowledgement for each of the one or more frames.

4. The apparatus of claim 1, wherein the processing system is configured to:
obtain one or more frames from the wireless node;
determine a received power associated with the one or more frames; and
generate the request based on the received power of the one or more frames.

5. The apparatus of claim 1, wherein the processing system is configured to generate the request based on a difference between a maximum transmit power and a transmit power associated with the first frame, a distance between the apparatus and the wireless node being above a threshold, or the processing system entering a low power mode.

6. The apparatus of claim 1, wherein the processing system is configured to place the request in an HE variant of an HT control field of the first frame.

7. The apparatus of claim 1, wherein the third frame comprises a trigger frame for triggering the transmission of the second frame.

8. The apparatus of claim 1, wherein the third frame comprises a data or control frame, and wherein the assignment of the second set of parameters channel includes a channel assignment situated in a trigger resource scheduling (TRS) field of the data or control frame.

9. A method for wireless communication, comprising:
generating a first frame including a request to change an assignment from a first set of channel parameters to a second set of channel parameters;
outputting the first frame for transmission to a wireless node in accordance with the first set of channel parameters;
obtaining a second frame from the wireless node, wherein the second frame includes the assignment of the second set of channel parameters;
generating a third frame; and
outputting the third frame for transmission to the wireless node in accordance with the second set of channel parameters.

10. The method of claim 9, wherein the first set of channel parameters specifies a first bandwidth, wherein the second set of channel parameters specifies a second bandwidth, and wherein the first bandwidth is different than the second bandwidth.

11. The method of claim 9, further comprising:
generating one or more frames prior to generating the first frame; and
outputting the one or more frames for transmission to the wireless node in accordance with the first set of channel parameters, wherein the request is based on not receiving an acknowledgement for each of the one or more frames.

12. The method of claim 9, further comprising:
obtaining one or more frames from the wireless node prior to generating the first frame;
determining a received power associated with the one or more frames; and
generating the request based on the received power of the one or more frames.

13. The method of claim 9, further comprising generating the request based on a difference between a maximum transmit power and a transmit power associated with the first frame, a distance between the apparatus and the wireless node being above a threshold, or the processing system entering a low power mode.

14. The method of claim 9, wherein the request is situated in an HE variant of an HT control field of the first frame.

15. The method of claim 9, wherein the second frame comprises a trigger frame for triggering the transmission of the third frame.

16. The method of claim 9, wherein the second frame comprises a data or control frame, and wherein the assignment of the second set of channel parameters includes a channel assignment situated in a trigger resource scheduling (TRS) field of the data or control frame.

17. An apparatus for wireless communication, comprising:
an interface configured to:
obtain a first frame from a wireless node in accordance with a first set of channel parameters, wherein the first frame includes a request for an assignment for the wireless node from a first set of channel parameters to a second set of channel parameters;
output a second frame for transmission to the wireless node; and
obtain a third frame from the wireless node in accordance with the second set of channel parameters; and
a processing system configured to generate the second frame based on the request, wherein the second frame includes an assignment of the second set of channel parameters to the wireless node.

18. The apparatus of claim 17, wherein the first set of channel parameters specifies a first bandwidth, wherein the second set of channel parameters specifies a second bandwidth, and wherein the first bandwidth is different than the second bandwidth.

19. The apparatus of claim 17, wherein the request is based on the wireless node not receiving a response to one or more frames transmitted by the wireless node.

20. The apparatus of claim 17, wherein the processing system is further configured to generate one or more frames, wherein the interface is configured to output the one or more frames for transmission to the wireless node, and wherein the request is based on the received power of the one or more frames at the wireless node.

21. The apparatus of claim 17, wherein the request is based on a difference between a maximum transmit power of the wireless node and a transmit power associated with the first frame, a distance between the apparatus and the wireless node being above a threshold, or the processing system entering a low power mode.

22. The apparatus of claim 17, wherein the request is situated in an HE variant of an HT control field of the first frame.

23. The apparatus of claim 17, wherein the second frame comprises a trigger frame for triggering the transmission of the third frame by the wireless node or a data or control frame, wherein the assignment of the second set of channel parameters includes a channel assignment situated in a trigger resource scheduling (TRS) field of the data or control frame.

24. A method for wireless communication, comprising:
receiving a first frame from a wireless node in accordance with a first set of channel parameters, wherein the first frame includes a request for an assignment for the wireless node from the first set of channel parameters to a second set of channel parameters;
generating a second frame based on the request, wherein the second frame includes an assignment of the second set of channel parameters to the wireless node;
outputting the second frame for transmission to the wireless node; and
receiving a third frame in accordance with the second set of channel parameters.

25. The method of claim 24, wherein the first set of channel parameters specifies a first bandwidth, wherein the second set of channel parameters specifies a second bandwidth, and wherein the first bandwidth is different than the second bandwidth.

26. The method of claim 24, wherein the request is based on the wireless node not receiving a response to one or more frames transmitted by the wireless node.

27. The method of claim 24, further comprising:
generating one or more frames; and
outputting the one or more frames for transmission to the wireless node, wherein the request is based on the received power of the one or more frames at the wireless node.

28. The method of claim 24, wherein the request is based on a difference between a maximum transmit power of the wireless node and a transmit power associated with the first frame, a distance between the apparatus and the wireless node being above a threshold, or the processing system entering a low power mode.

29. The method of claim 24, wherein the request an HE variant of an HT control field of the first frame.

30. The method of claim 24, wherein the second frame comprises a trigger frame for triggering the transmission of the third frame by the wireless node, or a data or control frame, wherein the assignment of the second set of channel parameters specifies a channel assignment situated in a trigger resource scheduling (TRS) field of the data or control frame.
